(19) United States
(12) Patent Application Publication
(10) Pub. No.: US 2007/0069853 A1
(43) Pub. Date: Mar. 29, 2007

(54) Anti-theft chip control device of automobile

(76) Inventor: Kung-Cheng Chang, Hsinchu (TW)

Correspondence Address: TROXELL LAW OFFICE PLLC, Suite 1404, 5205 Leesburg Pike, Falls Church, VA, 22041, US

(21) Appl. No.: 11/236,587

(22) Filed: Sep. 28, 2005

(51) Int. Cl. G05B 19/00

(52) U.S. Cl. 340/5.65; 340/5.72

(57) ABSTRACT

An anti-theft chip control device of automobile comprises: a key on which an inductance-rechargeable power source of chips and an actuation chipset having at least an actuation chip are mounted; and a plurality of protection chips having a first protection chip mounted between an automobile lock and an automobile power source, a second protection chip mounted between the automobile lock and a high-voltage coil, and a third protection chip mounted between the high-voltage coil and a spark plug, wherein all the protection chips are connected to the automobile lock and designed for sending feedback signals for the automobile lock. The automobile can be actuated if all signals of the actuation chips match that of these protection chips. On the contrary, the automobile cannot be actuated if one signal of the actuation chips does not match that of these protection chips.

### FIELD OF THE INVENTION

The present invention relates to an anti-theft chip control device of automobile, and more particularly to a control device for actuating the automobile and providing the automobile with anti-theft effect and safety.

### BACKGROUND OF THE INVENTION

With rapid development of automobile industry, all automobile manufacturers try to disclose anti-theft automobiles actively so as to reduce the proportion of stolen automobiles. Besides, consumers are usually attracted to the well-designed automobiles. In recent years, the chip has been applied to the anti-theft design in which the chip is mounted on the key and the automobile is provided with the built-in signal control loop. When inserting the key into the keyhole for switching on the automobile power source, the chip mounted on the key will send a signal to the signal control loop for comparison. If the signal is incorrect, the automobile power source cannot be switched on. If the signal is correct, the control machine of the automobile will switch on the automobile power source for actuating the automobile normally.

However, the automobile is actuated only if the signal of the chip matches that of the signal control loop. However, the conventional control system is designed to set an actuation signal on the actuation loop. When sending the feedback signal to this predetermined actuation loop for notifying that this chip is correct, the automobile is actuated. But, most thieves can crack this kind of simple single control. As a result, the major subject of the present invention is to provide a complex anti-theft chip control device having several control loops.

### SUMMARY OF THE INVENTION

The major object of the present invention is to provide an anti-theft chip control device for the automobile. At least two actuation chips are embedded in a key of the automobile, and protection chips are located among an automobile power source, a high-voltage coil, and a spark plug. As a result, the purpose of multiple protections can be achieved by sending feedback signals for confirming whether the signals from the actuation chips are correct or not. Accordingly, the automobile will not be actuated even if one of the actuation chips of the key is cracked.

### BRIEF DESCRIPTION OF THE DRAWINGS

FIG. 1 is a flow diagram showing the control process of chips in accordance with the present invention.

FIG. 2 is a block diagram showing the recharge process of the key in accordance with the present invention.

FIG. 3 is a block diagram showing that the actuation chipset switches on the automobile power source in accordance with the present invention.

FIG. 4 is a block diagram showing that the signals of the actuation chips do not match that of the protection chips in accordance with the present invention.

FIG. 5 is another block diagram showing that the actuation chipset switches on the automobile power source in accordance with the present invention.

FIG. 6 is another block diagram showing that the signals of the actuation chips do not match that of the protection chips in accordance with the present invention.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

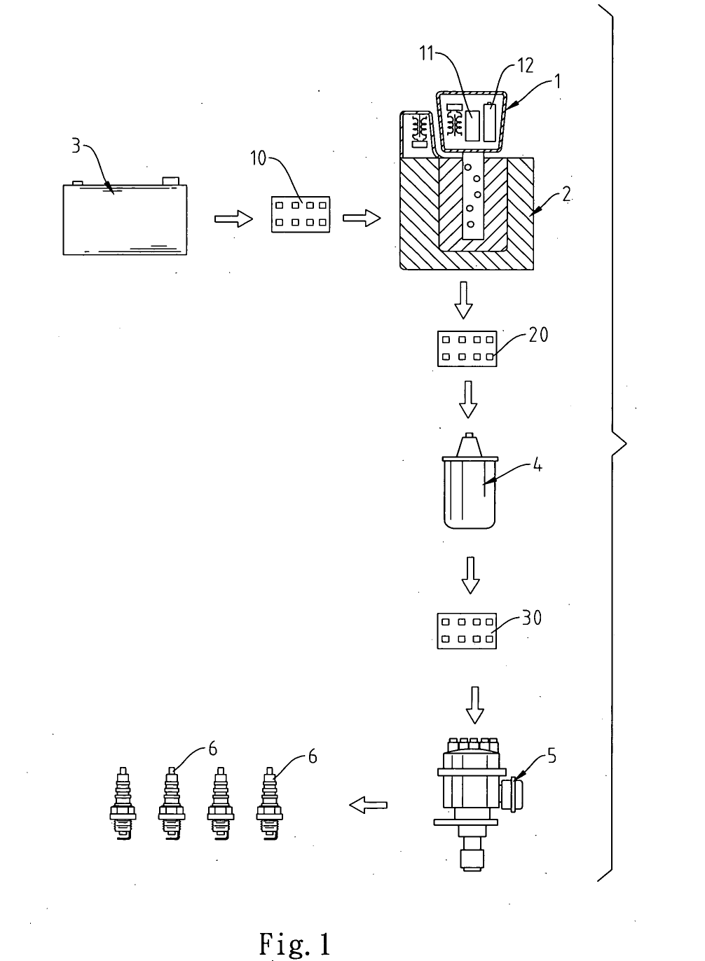

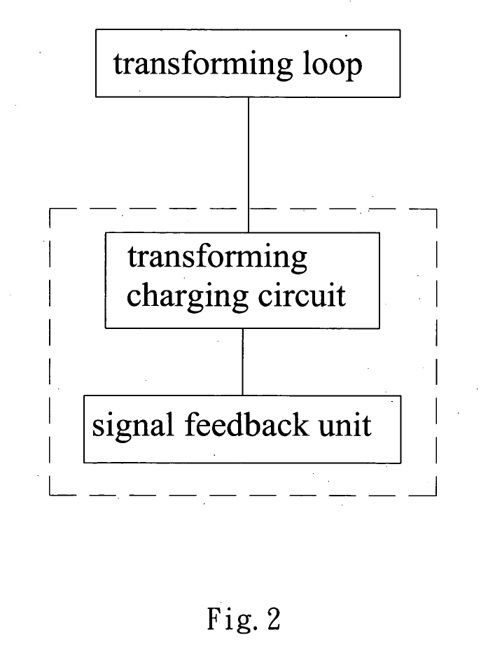

Referring to FIG. 1 and FIG. 2, in the anti-theft chip control device of the present invention, protection chips are provided for anti-theft control loops of automobile power source. The automobile lock 2 is designed to switch on the automobile power source and to provide the automobile power source for the automobile. The key 1 disclosed in the present invention has an actuation chipset 11 and a power source of chips 12 mounted therein. In addition, the actuation chipset 11 has at least an actuation chip mounted therein, and the power source of chips 12 mounted inside the key 1 is charged by the automobile power source and an inductance circuit when inserting the key 1 into the automobile lock 2.

A first protection chip 10, a second protection chip 20, and a third protection chip 30 are mounted among the automobile power source 3, a high-voltage coil 4, a distributor 5, and a spark plug 6. For instance, the automobile power source will not be switched on if the signal from either actuation chip of the actuation chipset 11 does not match that of the second protection chip 20.

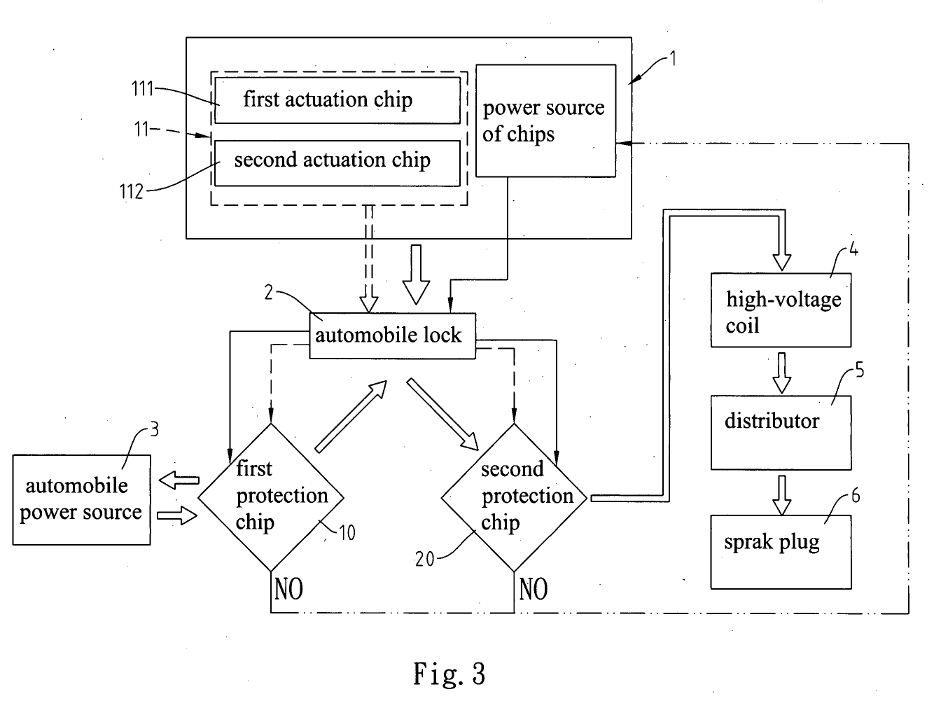

Referring further to FIG. 3, the automobile will be actuated only if the signals from the first actuation chip 111 and the second actuation chip 112 of the actuation chipset 11 mounted inside the key 1 match that of the first protection chip 10 and the second protection chip 20 when inserting the key 1 into the automobile lock 2. In the anti-theft control loops of automobile, the first protection chip 10 is mounted between the automobile power source 3 and the automobile lock 2, and the second protection chip 20 is mounted between the automobile lock 2 and the high-voltage coil 4. As a result, as long as the first actuation chip 111 of the key 1 matches the first protection chip 4 in a first signal comparison, a second signal comparison is then performed to compare the signal of the second actuation chip 112 with that of the second protection chip 20. If they match with one another in this second signal comparison, the automobile power source 3 supplies electric power for the high-voltage coil 4 and the spark plug 6 for actuating the automobile.

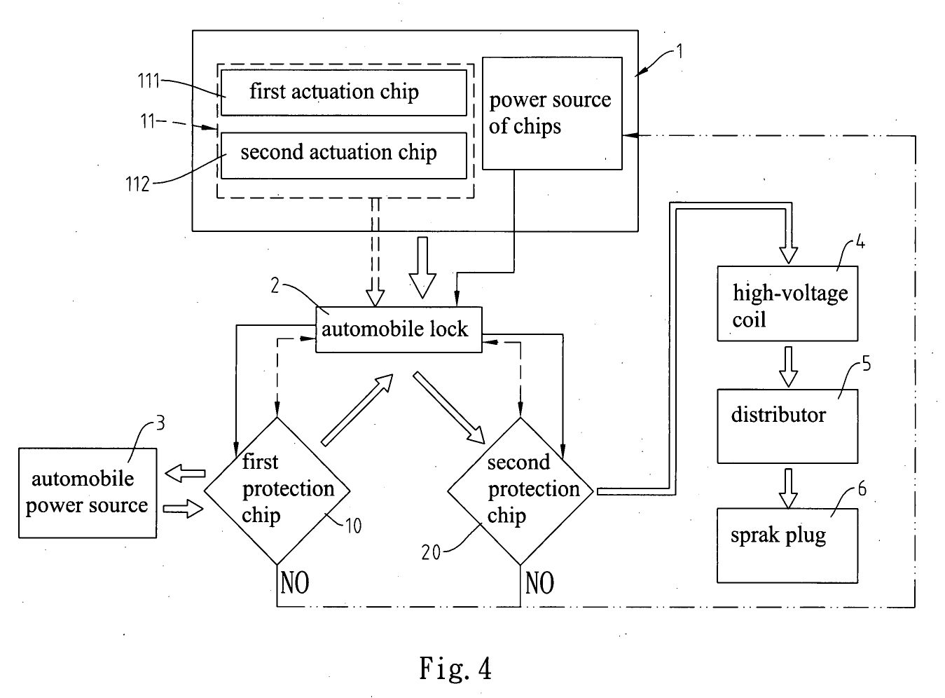

Referring further to FIG. 4, if the first actuation chip 111 or the second actuation chip 112 does not match the corresponding first protection chip 10 or second protection chip 20 in signal comparisons, a feedback signal is sent from the first or second protection chip to the automobile lock 2 such that the automobile lock 2 will not notify the automobile power source 3 to supply electric power. As a result, the automobile will not be actuated.

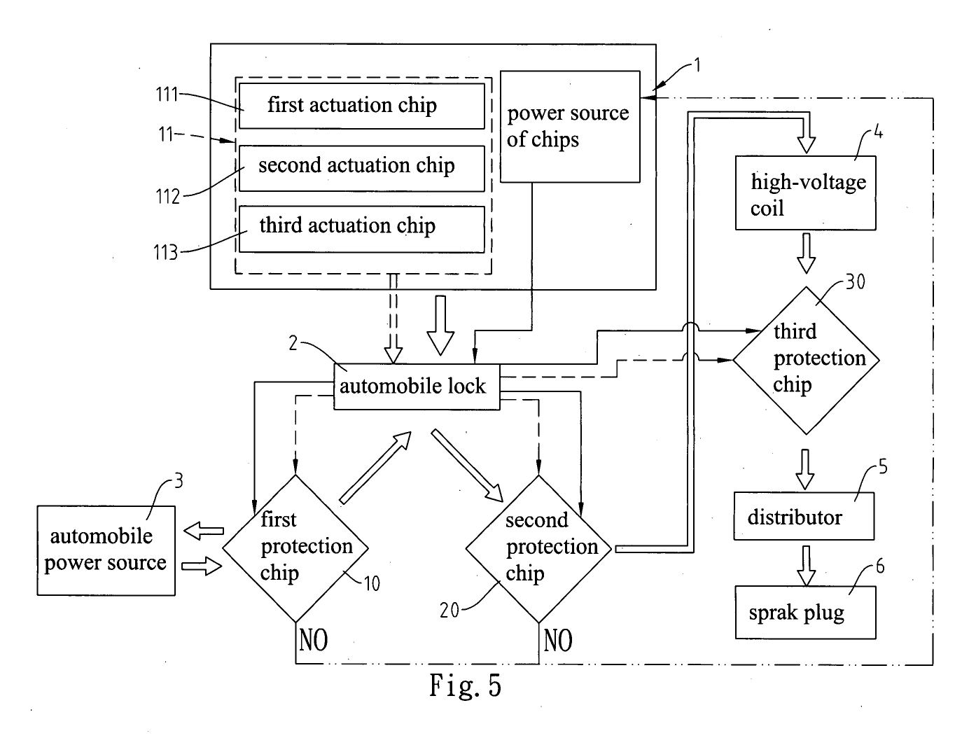

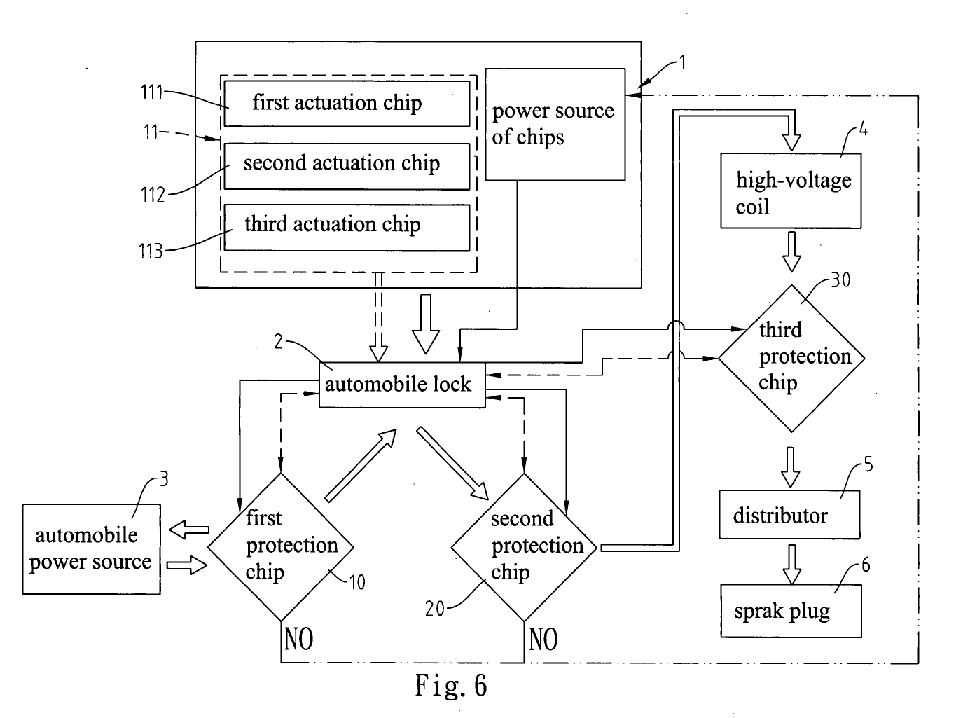

The aforementioned actuation chipset 11 of the key 1 is provided with two actuation chips. Referring to the preferred embodiment shown in FIG. 5 and FIG. 6, the actuation chipset 11 of the key 1 is provided with three actuation chips. As shown in FIG. 5, in the anti-theft control loops of automobile, the first protection chip 10 is mounted between the automobile power source 3 and the automobile lock 2, the second protection chip 20 is mounted between the automobile lock 2 and the high-voltage coil 4, and the third protection is further mounted between the high-voltage coil 4 and the spark plug 6, wherein these three protection chips are all connected to automobile lock 2. As long as all signals of the first actuation chip 111, second actuation chip 112, and third actuation chip 113 match that of the corresponding first protection chip 10, second protection chip 20, and third protection chip 30, these protection chips send feedback signals to the automobile lock 2 so as to switch on the supply of the electric power.

As shown in FIG. 6, in the anti-theft control loops of automobile, the first protection chip 10 is mounted between the automobile power source 3 and the automobile lock 2, the second protection chip 20 is mounted between the automobile lock 2 and the high-voltage coil 4, and the third protection is further mounted between the high-voltage coil 4 and the spark plug 6, wherein these three protection chips are all connected to automobile lock 2. As long as the signal from the first actuation chip 111, second actuation chip 112, or third actuation chip 113 does not match that of the corresponding first protection chip 10, second protection chip 20, or third protection chip 30, these protection chips send feedback signals to the automobile lock 2 to avoid the supply of the electric power.

What the invention claimed is:

1. An anti-theft chip control device of automobile having a plurality of anti-theft control loops comprising:
a key on which an actuation chipset and a power source of chips are mounted, wherein the actuation chipset has at least an actuation chip mounted therein and the power source of chips is an inductance-rechargeable power source; and
a plurality of protection chips having a first protection chip mounted between an automobile lock and an automobile power source and a second protection chip mounted between the automobile lock and a high-voltage coil, wherein all the protection chips are connected to the automobile lock and designed for sending feedback signals for the automobile lock.

2. An anti-theft chip control device of automobile having a plurality of anti-theft control loops comprising:
a key on which an actuation chipset and a power source of chips are mounted, wherein the actuation chipset has at least an actuation chip mounted therein and the power source of chips is an inductance-rechargeable power source; and
a plurality of protection chips having a first protection chip mounted between an automobile lock and an automobile power source, a second protection chip mounted between the automobile lock and a high-voltage coil, and a third protection chip mounted between the high-voltage coil and a spark plug, wherein all the protection chips are connected to the automobile lock and designed for sending feedback signals for the automobile lock.
